(19) United States
(12) Patent Application Publication
(10) Pub. No.: US 2003/0058536 A1
(43) Pub. Date: Mar. 27, 2003

(54) Multi-port reflective optical isolator

(76) Inventors: Chen-Bin Huang, Hsichu (TW); Chieh Hu, Taichung (TW)

Correspondence Address: BIRCH STEWART KOLASCH & BIRCH, PO BOX 747, FALLS CHURCH, VA, 22040-0747, US

(21) Appl. No.: 10/020,917

(22) Filed: Dec. 19, 2001

(30) Foreign Application Priority Data
Sep. 26, 2001 (TW) 90123680

(51) Int. Cl. G02B 27/28; G02B 6/27

(52) U.S. Cl. 359/495; 385/11; 359/494

(57) ABSTRACT

A multi-port optical isolator includes a plurality of optical input/output ports formed on one side of the isolator, a polarization splitter/combiner, a non-reciprocal polarization rotator module and a non-reciprocal reflector. Light beams entering the input ports can be guided to corresponding output ports while noise beams traveling in reverse direction can be blocked. By using reflective elements for managing the beam path, the length of the isolator can be greatly reduced, and multiple unitary isolators can be built in an isolator with a similar size to that of common single port isolators.

### BACKGROUND OF THE INVENTION

1. Field of the Invention

The invention generally relates to a fiber optic passive device, and more particularly relates to an optical isolator capable of restricting light ray transmitting in one way only. A non-reciprocal reflector is used to shorten the length of the optical element. A plurality of input/output ports allocated in an array make a high density multiple port optical isolator.

2. Related Art

An optical isolator is a device that permits light signals in an optical fiber to travel in one direction and blocks light signals in the opposite direction. Manufacturing processes for optical isolators are well known. Optical isolators are usually applied in light emitters, light amplifiers and high-speed optical communication networks for reducing signal noise. In present days optical fiber technology, semiconductor lasers are typically used to generate and to relay light signals on optical fibers. These lasers are particularly susceptible to light signal reflections, which cause a laser to become unstable and noisy. Optical isolators are used to block these reflected signals and prevent them from reaching the laser. Ideally, these optical isolators transmit all of the light signals in the forward direction and block all of the signals in the reverse direction. An optical amplifier also has to avoid amplified spontaneous emission and noise. Therefore, optical isolators are used to fulfill the aforesaid requirements.

There are many optical isolators disclosed in prior arts, for example, in U.S. Pat. Nos. 5,325,456; 5,317,655; 5,581,640; 5,825,950; and 6,028,702. These optical isolators are commonly made with a single optical isolator. Some multi-port optical isolators are also disclosed in U.S. Pat. Nos. 5,706,371; 6,075,642; 6,167,174, and WO 00/48029. Though these optical isolators include a plurality of isolators, they use light transmission means and are thus longer in length.

In the aforesaid multi-port optical isolators of U.S. Pat. No. 5,706,371 and WO 00/48029, the construction of each isolator is substantially the same as the unitary optical isolator of U.S. Pat. No. 5,581,640. The difference between them is that the input/output ports are replaced with an optical fiber and lens, therefore they are single stage isolators that create polarization mode dispersion problems.

### SUMMARY OF THE INVENTION

It is therefore an object of the invention to provide a multi-port optical isolator that can be fabricated in a package with low cost and a simple process.

The invention utilizes an optical port array for input and output ports. The array makes the optical isolator a multiple port isolator with a similar size to that of common single port isolators.

Another object of the invention is to provide an optical isolator with a shorter length. An optical isolator according to the invention includes a plurality of optical input/output ports formed on one side of the isolator, a polarization splitter/combiner, a non-reciprocal polarization rotator module and a non-reciprocal reflector. By means of reflection of the non-reciprocal reflector and the location of all the optical elements, reflective rays can be guided through a predetermined return beam path to respondent output ports and leave the optical isolator. The repeated usage of the optical elements thus greatly reduces the length of the optical isolator and reduces the cost of manufacturing.

A further object of the invention is to provide an optical isolator utilizing a non-reciprocal reflector and a non-reciprocal polarization rotator module so as to solve the problems of polarization mode dispersion (PMD) and polarization dependent loss (PDL).

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a systematic block diagram of an optical isolator according to the invention;

FIG. 2 is a constructional view of a first embodiment of the invention;

FIGS. 3A to 3E are functional views of the first embodiment of the invention showing the beam paths and polarization of incident beams coming into the reflective isolator;

FIGS. 4A to 4E are functional views of the first embodiment of the invention showing beams coming in reverse direction from output ports of the isolator and being blocked therein;

FIG. 5 is a constructional view of a second embodiment of the invention;

FIGS. 6A to 6F are functional views of the second embodiment of the invention showing the beam paths and polarization of incident beams coming into the reflective isolator;

FIGS. 7A to 7F are functional views of the second embodiment of the invention showing beams coming in reverse direction from output ports of the isolator and being blocked therein;

FIG. 8 is a constructional view of a third embodiment of the invention;

FIGS. 9A to 9E are functional views of the third embodiment of the invention showing the beam paths and polarization of incident beams coming into the reflective isolator;

FIGS. 10A to 10E are functional views of the third embodiment of the invention showing beams coming in reverse direction from output ports of the isolator and being blocked therein;

FIG. 11 is a constructional view of a fourth embodiment of the invention;

FIGS. 12A to 12F are functional views of the fourth embodiment of the invention showing the beam paths and polarization of incident beams coming into the reflective isolator;

FIGS. 13A to 13F are functional views of the third embodiment of the invention showing beams coming in reverse direction from output ports of the isolator and being blocked therein;

FIG. 14 is a constructional view of a first embodiment of an array beam collimator used in the invention;

FIG. 15 is a constructional view of a second embodiment of an array beam collimator used in the invention;

FIG. 16 is a constructional view of a fifth embodiment of the invention in which the input/output port array is increased;

FIGS. 17A to 17E are functional views of the fifth embodiment of the invention showing the beam paths and polarization of incident beams coming into the reflective isolator; and

FIGS. 18A to 18E are functional views of the fifth embodiment of the invention showing beams coming in reverse direction from output ports of the isolator and being blocked therein.

### DETAILED DESCRIPTION OF THE INVENTION

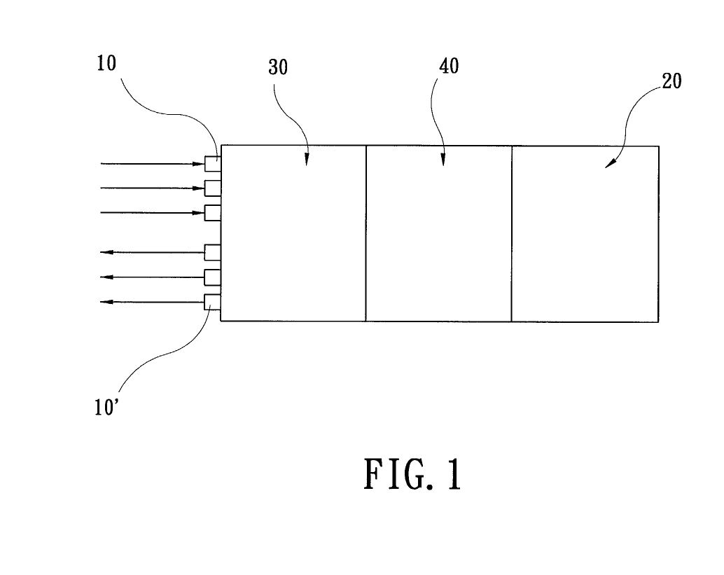

As shown in FIG. 1, a reflective optical isolator according to the invention includes several pairs of light input ports 10 and output ports 10′ located on one side of the isolator. Any incident ray coming into an input port 10 will transmit to a corresponding output port 10′. A non-reciprocal reflector 20, located on an end of the isolator, preferably on the opposite side of the input/output ports 10 and 10′, is used to reflect the ray entering the input port 10 to the corresponding output port 10′. A polarization splitter/combiner 30 is located in the beam path between the light input/output ports 10 and 10′ and the non-reciprocal reflector 20. By the reflective isolation function of the invention, the incident beam and the return beam of reflection coming from different directions to the polarization splitter/combiner 30 are isolated or combined so as to totally block the reflective beam traveling in the reverse direction. A non-reciprocal polarization rotator 40, located in the beam path between the polarization splitter/combiner 30 and the non-reciprocal reflector 20, is used to change the linear polarization directions of light beams passing through. The direction of polarization rotation is designed according to the poles of the polarization axis of the polarization splitter/combiner 30 in the beam path of the incident and return beams. Therefore, the beams travelling in different directions can be changed with different linear polarization directions. As a result, the return beam passing through the polarization splitter/combiner 30 is guided to the output port 10′, while the beam coming into the output port 10′ in a reverse direction is effectively blocked.

The aforesaid non-reciprocal reflector 20 and non-reciprocal polarization rotator 40 can be made of non-reciprocal crystal. A characteristic of a non-reciprocal crystal is that when a ray travels along the Z-axis twice (forward and return) through the crystal, the polarization changes are additive. A commonly used non-reciprocal crystal is a Faraday rotator or a quarter-wave plate. On the other hand, a reciprocal crystal, such as a half-wave plate, has different characteristics.

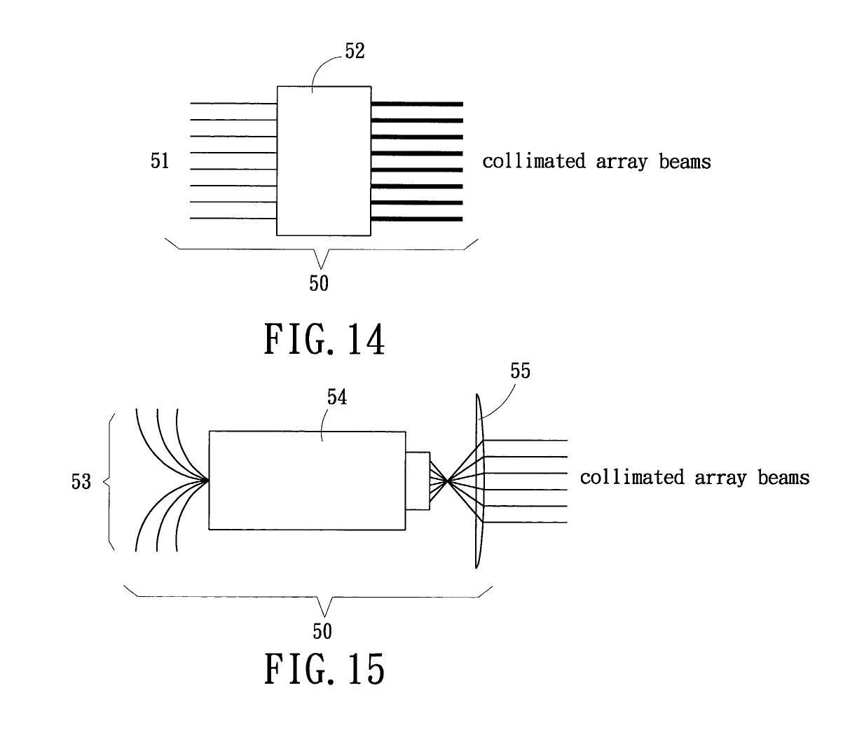

The reflective optical isolator of the invention can be applied to a multi-port arrangement. A laser beam generated by a laser generator can pass through a collimator array 50 into array beams for input to the input ports, for example, 10a, 10b and 10c of the isolator. The collimator array 50 can be made as follows. A first embodiment of that is shown in FIG. 14. An optical fiber array 51 is connected to the laser generator. Several collimator lenses located in an array 52 are coupled to the output ends of the optical fiber array 51 so as to provide collimated array beams. A second embodiment of the collimator array 50 is shown in FIG. 15. An optical fiber array 53 is connected to a GRIN lens 54 (having gradient refractive indexes) for producing collimated beams. Then a focusing lens 55 is used to collimate the array beams. In the following description, the beam paths between the input ports 10 and the non-reciprocal reflector 20 are called incident beam paths. The beam paths between the non-reciprocal reflector 20 and the output ports are called return beam paths. The incident laser beams are led to the input ports 10a, 10b, and 10c, and finally come out from the output ports 10a′, 10b′, and 10c′ respectively. Embodiments of the reflective optical isolator according to the invention are described in detail as follows.

First Embodiment

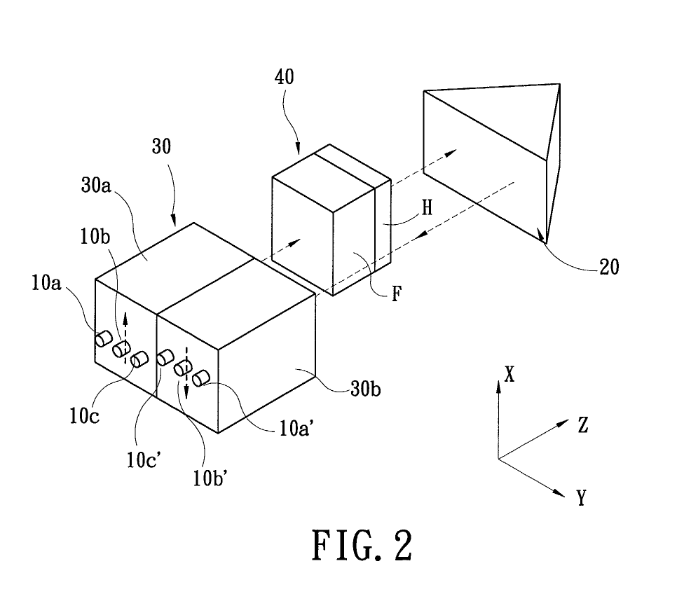

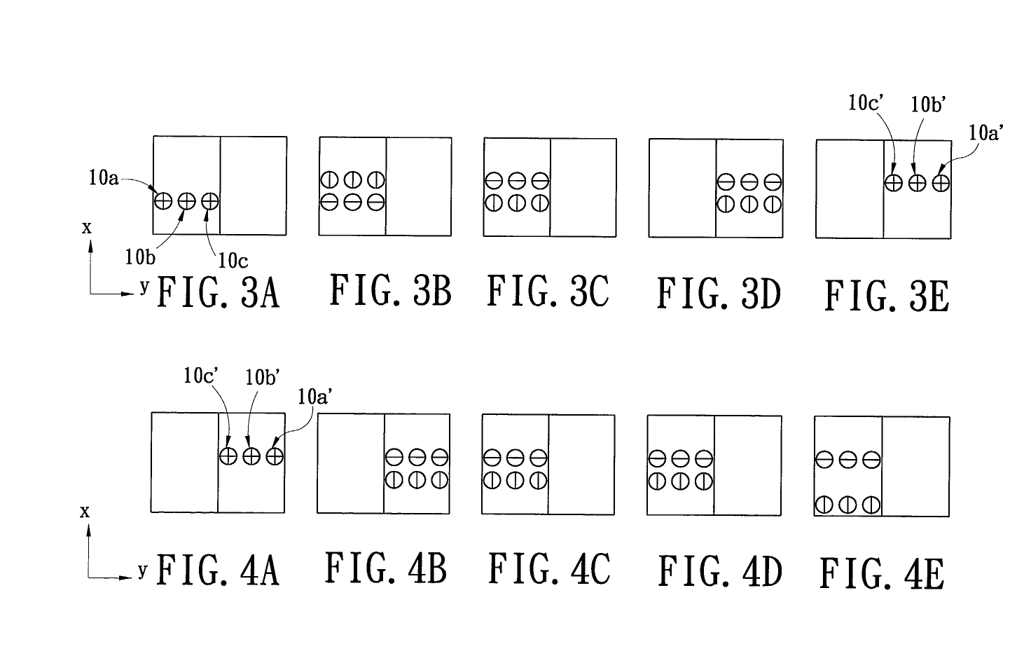

As shown in FIG. 2, in the first embodiment the polarization splitter/combiner 30 is a birefringent crystal including a left half 30a located in the incident beam path, and a right half 30b located in the return beam path. The directions of the polarization axis of the left half 30a and the right half 30b are opposite to each other. The non-reciprocal polarization rotator 40 located in the incident beam path is composed of a Faraday crystal F and a half-wave plate H. The Faraday crystal F is near the polarization splitter/combiner 30, while the half-wave plate H is near the non-reciprocal reflector 20. The non-reciprocal polarization rotator 40 polarizes and rotates the incident beam 90 degrees. The non-reciprocal reflector 20 is a dihedral retro-reflector, such as a right-angle prism. For a birefringent crystal, such as an anisotropic crystal, the incident beams according to the polarization directions can be defined as extraordinary ray (E-ray) and ordinary ray (O-ray), which are perpendicular to each other. For linear polarization beams, the angle between the two polarization rays is 90 degrees. The O-ray obeys Snell's Law in that its direction of travel is parallel to the energy transmission direction. But the E-ray, generally having a direction of travel different from that of the O-ray, transmits its energy in a different direction, called walk-off, according to the polarization direction of the crystal. For convenience of further description, the polarization axis direction of the left half 30a and the right half 30b are defined herein as +X and −X respectively. The optical axis of the reflective isolator is designated in the drawings with the Z-axis of an X-Y-Z coordinate graph. The polarization directions of the light beams are illustrated with circles and diameter lines in the polarization directions. FIGS. 3A to 3E are functional views of the first embodiment of the invention showing the beam paths and polarization of incident beams coming into the reflective isolator. Random polarized incident beams are first led to the input ports 10a, 10b, and 10c and come to the left half 30a of the polarization splitter/combiner 30, as shown in FIG. 3A. After passing the polarization splitter/combiner 30, the beams are separated into two sets of orthogonal beams (FIG. 3B). The orthogonal beams then pass the non-reciprocal polarization rotator 40 and each rotates 90 degrees (observed from the incident direction of the beams). In other words, the E-rays that are parallel to the polarization axis of the left half 30a change into O-rays, as shown in FIG. 3C. The beams are further reflected by the non-reciprocal reflector 20 to reverse their direction of travel and become return beams. The non-reciprocal reflector 20 makes the light beams travel in a reverse direction and replace the right and left sides, as shown in FIG. 3D. Then, the return beams pass the right half 30b of the polarization splitter/combiner 30 so that those two sets of orthogonal beams are combined again and coupled to the output ports 10a′, 10b′, and 10c′.

FIGS. 4A to 4E are functional views of the first embodiment of the invention showing beams coming in reverse direction from output ports 10a′, 10b′, and 10c′ of the isolator and being blocked therein. Random polarized beams are led to the output ports 10a′, 10b′, and 10c′ and come to the right half 30b of the polarization splitter/combiner 30, as shown in FIG. 4A. After passing through the polarization splitter/combiner 30, the beams are separated into two sets of orthogonal beams (FIG. 4B). The linear polarized O-rays pass through the right half 30b, while the E-rays will walk-off downwards to the −X axis. The beams are further reflected by the non-reciprocal reflector 20 to reverse their direction of travel and replace the right and left sides, as shown in FIG. 4C. Then, the reversed beams pass through the non-reciprocal polarization rotator 40. Because of the non-reciprocal polarization, all the linear polarized beams do not rotate, as shown in FIG. 4D. The reversed beams further pass the left half 30a of the polarization splitter/combiner 30 so that the E-rays thereof will walk-off downwards, and the O-rays will pass through (FIG. 4E). As a result, the reversed beams are isolated and won't be coupled into the input ports 10a, 10b, and 10c.

Second Embodiment

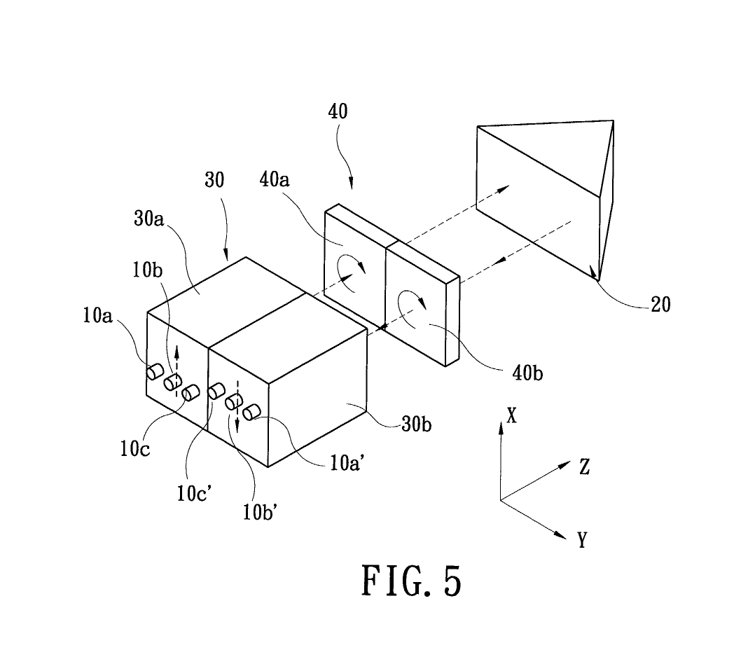

As shown in FIG. 5, in the second embodiment the polarization splitter/combiner 30 is also a birefringent crystal including a left half 30a located in the incident beam path, and a right half 30b located in the return beam path. The direction of the polarization axis of the left half 30a and the right half 30b are opposite to each other. The non-reciprocal polarization rotator 40 is composed of a Faraday crystal 40a located in the incident beam path and a half-wave plate 40b located in the return beam path. The non-reciprocal reflector 20 is a dihedral retro-reflector.

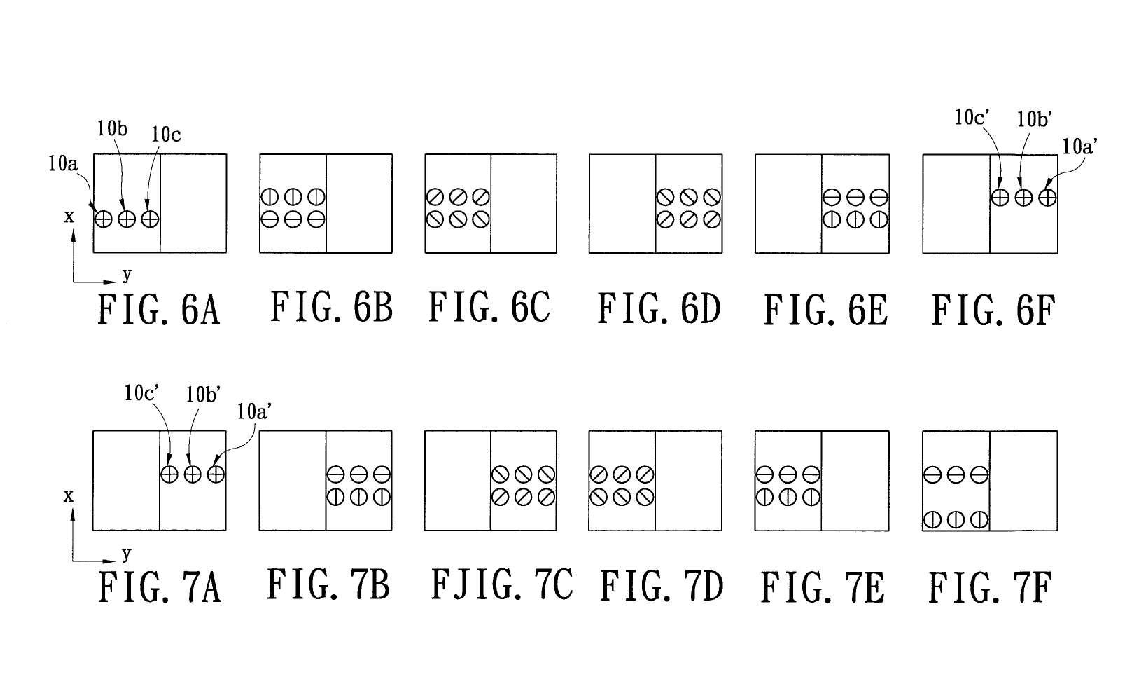

FIGS. 6A to 6F are functional views of the second embodiment of the invention showing the beam paths and polarization of incident beams coming into the reflective isolator. Random polarized incident beams are first led to the input ports 10a, 10b, and 10c and come to the left half 30a of the polarization splitter/combiner 30, as shown in FIG. 6A. After passing through the polarization splitter/combiner 30, the beams are separated into two sets of orthogonal beams (FIG. 6B). The orthogonal beams then pass the Faraday crystal 40a and each rotates 45 degrees (for example, clockwise) as shown in FIG. 6C. The beams are further reflected by the non-reciprocal reflector 20 to reverse their direction of travel into return beams and replace the right and left sides, as shown in FIG. 6D. The return beams passing through the half-wave plate 40b further rotate 45 degrees so that the O-rays travel on the top and the E-rays travel on the bottom, as shown in FIG. 6E. Finally, the beams pass through the right half 30b of the polarization splitter/combiner 30 where the E-rays walk-off to meet the O-rays and are combined and coupled to the output ports 10a′, 10b′, and 10c′ as shown in FIG. 6F.

Likewise, FIGS. 7A to 7F are functional views of the second embodiment of the invention showing beams coming in reverse direction from the output ports 10a′, 10b′, and 10c′ of the isolator and being blocked therein. Please refer to the drawings in which the meaning for the illustration of the polarization direction is the same as that described above.

Third Embodiment

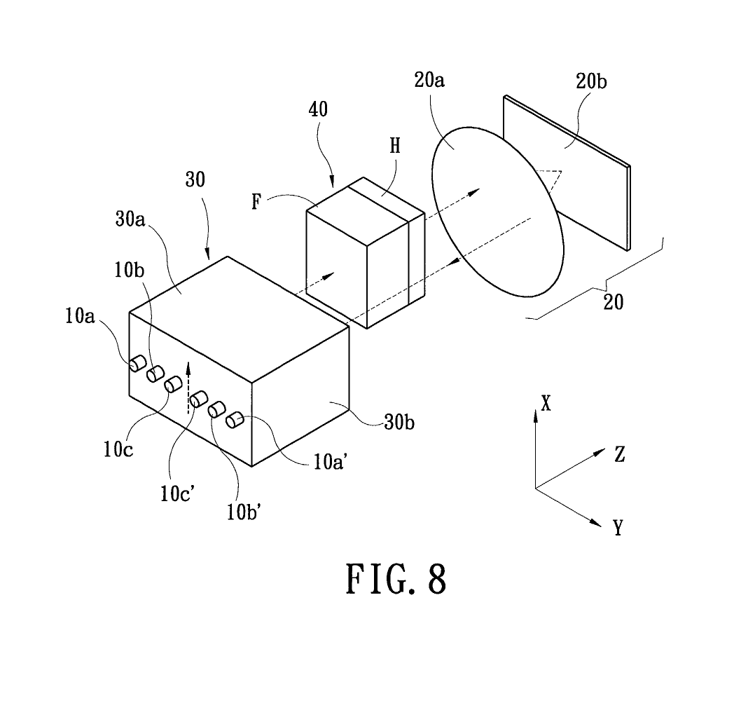

As shown in FIG. 8, in the third embodiment the polarization splitter/combiner 30 is also a birefringent crystal with only a polarization axis of +X. The non-reciprocal polarization rotator 40, located in the incident beam path, is composed of a Faraday crystal F and a half-wave plate H. The non-reciprocal reflector 20 is composed of a focusing lens 20a and a reflector 20b located in the focus plane of the focusing lens 20b.

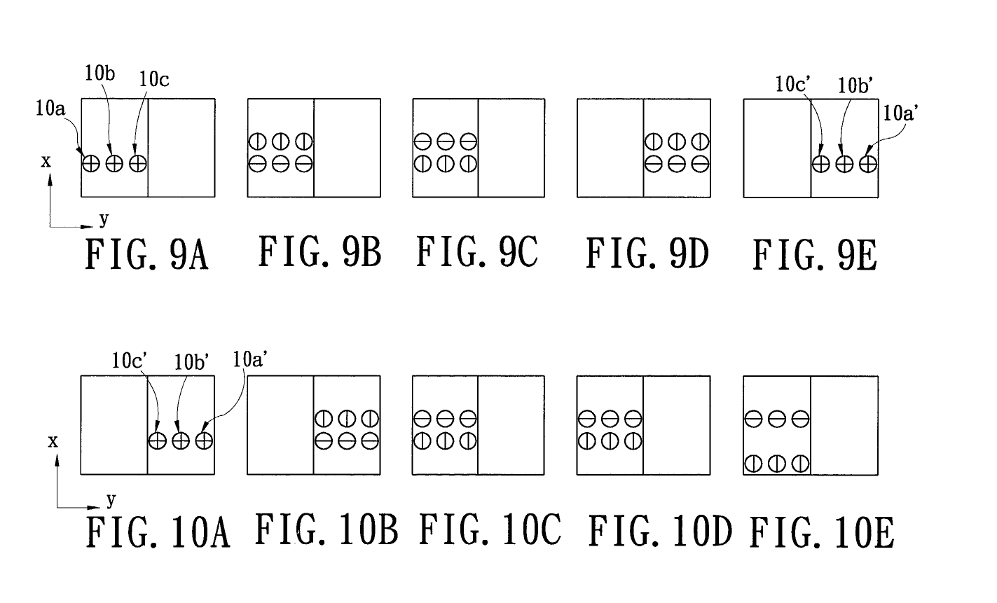

FIGS. 9A to 9E are functional views of the third embodiment of the invention showing the beam paths and polarization of incident beams coming into the reflective isolator. Random polarized incident beams are first led to the input ports 10a, 10b, and 10c and come to the polarization splitter/combiner 30, as shown in FIG. 9A. After passing through the polarization splitter/combiner 30, the beams are separated into two sets of orthogonal beams. The E-rays thereof walk-off toward the +X axis, while the O-rays directly pass through and travel under the E-rays, as shown in FIG. 9B. The beams further pass through the non-reciprocal polarization rotator 40 and rotate 90 degrees, as shown in FIG. 9C. The beams are further reflected by the non-reciprocal reflector 20 to reverse their direction of travel into return beams and replace the up and down and right and left sides, as shown in FIG. 9D, by means of the focusing lens 20a. Finally, the beams pass through the polarization splitter/combiner 30 where the E-rays walk-off to meet the O-rays and are combined and coupled to the output ports 10a′, 10b′, and 10c′ as shown in FIG. 9E. Likewise, FIGS. 10A to 10E are functional views of the third embodiment of the invention showing beams coming in reverse direction from the output ports 10a′, 10b′, and 10c′ of the isolator and being blocked therein. Please refer to the drawings in which the meaning for the illustration of the polarization direction is the same as that described above.

Fourth Embodiment

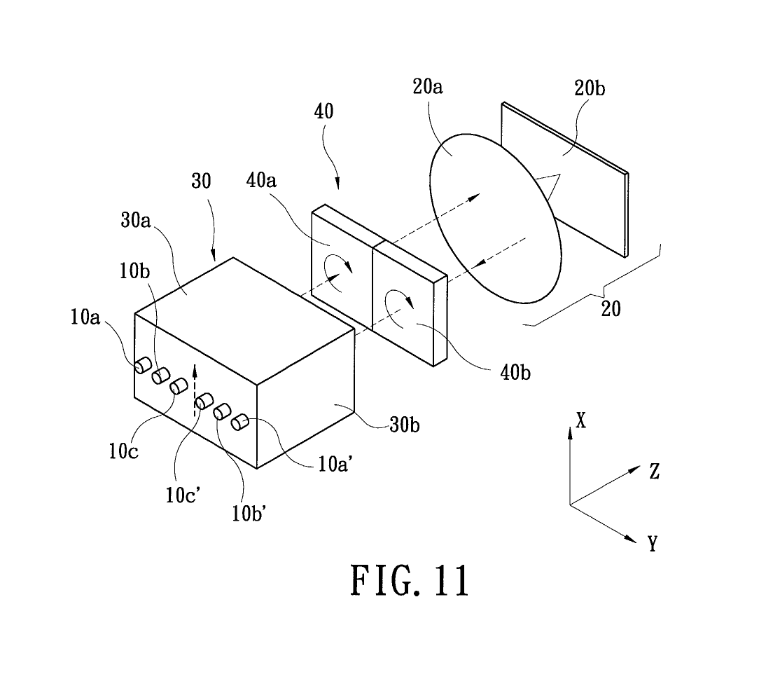

As shown in FIG. 11, in the fourth embodiment the polarization splitter/combiner 30 is also a birefringent crystal with only a polarization axis of +X. The non-reciprocal polarization rotator 40 is composed of a Faraday crystal 40a located in the incident beam path, and a half-wave plate 40b located in the return beam path. The polarization direction of the Faraday crystal 40a and the half-wave plate 40b are opposite to each other. The non-reciprocal reflector 20 is composed of a focusing lens 20a and a reflector 20b located in the focus plane of the focusing lens 20b.

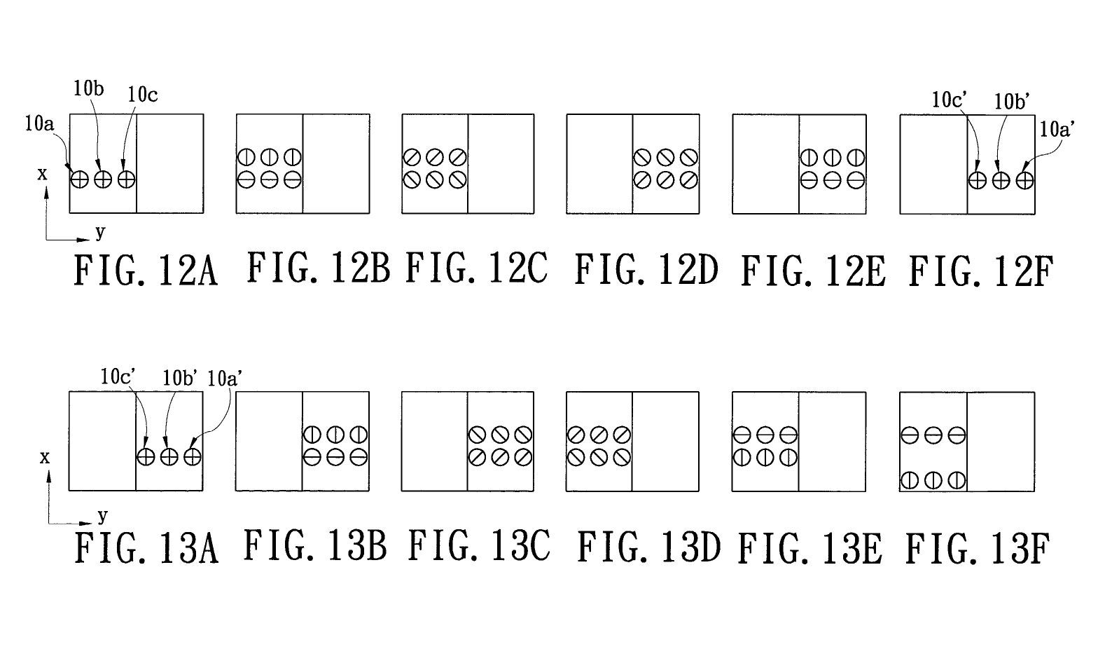

FIGS. 12A to 12F are functional views of the fourth embodiment of the invention showing the beam paths and polarization of incident beams coming into the reflective isolator. Random polarized incident beams are first led to the input ports 10a, 10b, and 10c and come to the polarization splitter/combiner 30, as shown in FIG. 12A. After passing through the polarization splitter/combiner 30, the beams are separated into two sets of orthogonal beams. The E-rays thereof walk-off toward the +X axis, while the O-rays directly pass through and travel under the E-rays, as shown in FIG. 12B. The beams further pass through the non-reciprocal polarization rotator 40 and rotate 45 degrees clockwise, as shown in FIG. 12C. The beams are further reflected by the non-reciprocal reflector 20 to reverse their direction of travel into return beams and replace the up and down and right and left sides, as shown in FIG. 12D, by means of the focusing lens 20a. The beams further pass through the half-wave plate 40b and rotate 45 degrees clockwise so that the E-rays travel on the top while the O-rays travel on the bottom, as shown in FIG. 12E. Finally, the beams pass through the polarization splitter/combiner 30 where the E-rays walk-off to meet the O-rays and are combined and coupled to the output ports 10a′, 10b′, and 10c′, as shown in FIG. 12F.

Likewise, FIGS. 13A to 13F are functional views of the fourth embodiment of the invention showing beams coming in reverse direction from the output ports 10a′, 10b′, and 10c′ of the isolator and being blocked therein. Please refer to the drawings in which the meaning for the illustration of the polarization direction is the same as that described above.

Fifth Embodiment

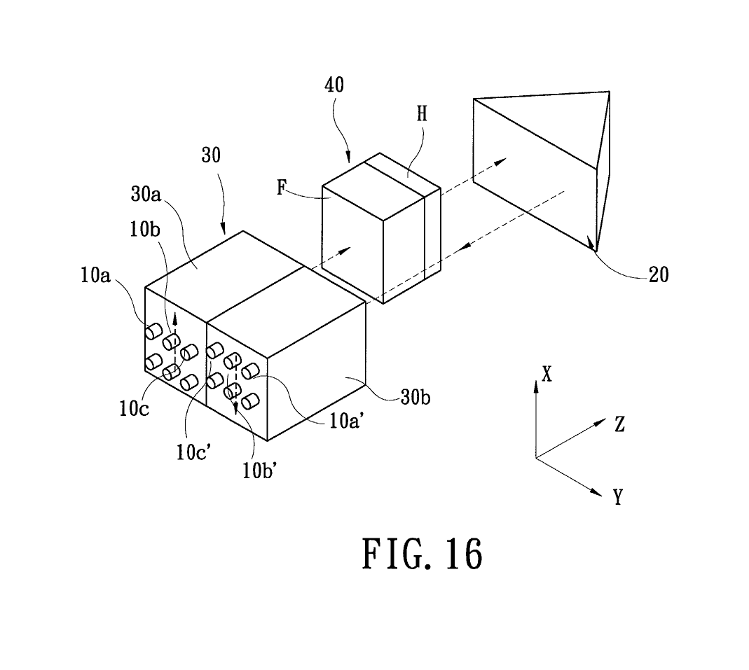

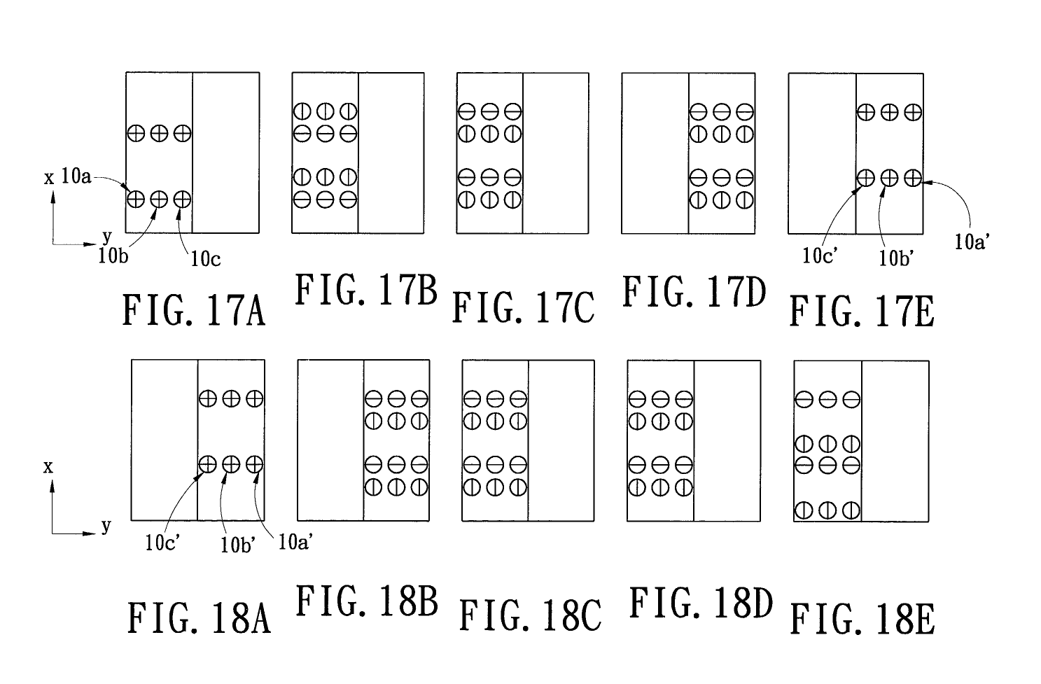

Now referring to FIGS. 16 to 18, when the collimated light beams are arranged in a two dimensional array, we can make the input and output ports arranged in such an array. In this case, only by increasing the crystalloid a little, a similar sized product that includes more unitary optical isolators can be obtained.

In conclusion, the invention utilizes reflective elements for managing the beam path. It greatly reduces the length of the product and the cost of manufacturing. By arranging the input/output ports in an array, the number of unitary isolators in the multi-port optical isolator can be further increased.

Moreover, because the invention incorporates non-reciprocal reflectors and non-reciprocal crystal assemblies to generate specific linear polarization and selectively control the walk-off of beams, it can solve the problems of polarization dependent loss and polarization mode dispersion.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multi-port reflective optical isolator comprising:
a plurality of pairs of light input and output ports located on one side of the isolator;
a non-reciprocal reflector, located on an opposite side of said input/output ports, for reflecting incident rays entering from said input ports and transmitting to correspondent output ports;.
a polarization splitter/combiner, located in a beam path between said light input/output ports and said non-reciprocal reflector for selectively isolating and combining forward and return beams travelling in different directions when said beams are passing through; and
a non-reciprocal polarization rotator, located in a beam path between said polarization splitter/combiner and said non-reciprocal reflector, for changing the linear polarization directions of light beams passing through so as to reflect said beams passing through said polarization splitter/combiner into said output ports, and to block beams entering said output ports in a reverse direction.

2. A multi-port reflective optical isolator according to claim 1 wherein said input and output ports are separately located, and preferably in an array.

3. A multi-port reflective optical isolator according to claim 1 wherein said polarization splitter/combiner is a birefringent crystal comprising a left half located in an incident beam path, and a right half located in a return beam path; directions of polarization axis of said left half and said right half are reverse to each other; said non-reciprocal polarization rotator located in said incident beam path is composed of a Faraday crystal and a half-wave plate; and said non-reciprocal reflector is a dihedral retro-reflector.

4. A multi-port reflective optical isolator according to claim 3 wherein said Faraday crystal is near said polarization splitter/combiner, and said half-wave plate is near said non-reciprocal reflector.

5. A multi-port reflective optical isolator according to claim 3 wherein a polarization rotation angle of said non-reciprocal polarization rotator is 90 degree.

6. A multi-port reflective optical isolator according to claim 3 wherein said non-reciprocal reflector is a right-angle prism.

7. A multi-port reflective optical isolator according to claim 1 wherein said polarization splitter/combiner is a birefringent crystal comprising a left half located in an incident beam path, and a right half located in a return beam path; directions of polarization axis of said left half and said right half are reverse to each other; said non-reciprocal polarization rotator comprises a Faraday crystal located in said incident beam path and a half-wave plate located in said return beam path; directions of polarization axis of said Faraday crystal and said half-wave plate are the same; and said non-reciprocal reflector is a dihedral retro-reflector.

8. A multi-port reflective optical isolator according to claim 7 wherein a polarization rotation angle of said non-reciprocal polarization rotator is 45 degree.

9. A multi-port reflective optical isolator according to claim 7 wherein said non-reciprocal reflector is a right-angle prism.

10. A multi-port reflective optical isolator according to claim 1 wherein said polarization splitter/combiner is a birefringent crystal having a single polarization; said non-reciprocal polarization rotator, located in an incident beam path, is composed of a Faraday crystal and a half-wave plate; and said non-reciprocal reflector is composed of a focusing lens and a reflector located in a focus plane of said focusing lens.

11. A multi-port reflective optical isolator according to claim 10 wherein said Faraday crystal is near said polarization splitter/combiner, and said half-wave plate is near said non-reciprocal reflector.

12. A multi-port reflective optical isolator according to claim 10 wherein a polarization rotation angle of said non-reciprocal polarization rotator is 90 degree.

13. A multi-port reflective optical isolator according to claim 1 wherein said polarization splitter/combiner is a birefringent crystal having a single polarization; said non-reciprocal polarization rotator comprises a Faraday crystal located in an incident beam path and a half-wave plate located in a return beam path; directions of polarization axis of said Faraday crystal and said half-wave plate are reverse to each other; and said non-reciprocal reflector is composed of a focusing lens and a reflector located in a focus plane of said focusing lens.

14. A multi-port reflective optical isolator according to claim 13 wherein a polarization rotation angle of said non-reciprocal polarization rotator is 45 degree.
